(19) United States
(12) Patent Application Publication
(10) Pub. No.: US 2010/0227947 A1
(43) Pub. Date: Sep. 9, 2010

(54) INK-JET INKS AND ENCAPSULATED PIGMENTS PREPARED BY RAFT REAGENTS

(76) Inventors: Sivapackia Ganapathiappan, Los Altos, CA (US); Howard S. Tom, San Jose, CA (US); Laurie S. Mittelstadt, Belmont, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/398,597

(22) Filed: Mar. 5, 2009

(51) Int. Cl. C08K 9/10

(52) U.S. Cl. 523/205

(57) ABSTRACT

The present disclosure is drawn to methods and compositions directed at encapsulated pigments. As such, an encapsulated pigment can comprise a pigment and a polymer encapsulating the pigment, where the polymer comprises a monomer and a RAFT reagent. Additionally, a method of encapsulating pigments can comprise dispersing a pigment in an aqueous solution to form a pigment dispersion, adding a monomer to the pigment dispersion, adding a RAFT reagent to the pigment dispersion, and polymerizing the monomer using the RAFT reagent in the presence of the pigment to form an encapsulated pigment. Further, the present disclosure provides ink-jet inks comprising the encapsulated pigments.

### BACKGROUND

There are several reasons that ink-jet printing has become a popular way of recording images on various media surfaces, particularly paper and photo media substrates. Some of these reasons include low printer noise, capability of high-speed recording, and capability of multi-color recording. Additionally, these advantages can be obtained at a relatively low price to consumers. With respect to ink-jet ink chemistry, the majority of commercial ink-jet inks are water-based. Thus, their constituents are generally water-soluble, as in the case with many dyes, or water dispersible, as in the case with pigments. Furthermore, ink-jet inks have low viscosity to accommodate high frequency jetting and firing chamber refill processes common to thermal ink-jet architecture.

As ink-jet ink applications have advanced, improvement of such printing systems through ongoing research and developmental efforts continue to be sought.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It must be noted that, as used in this specification and the appended claims, the singular forms “a,” “an,” and “the” include plural referents unless the context clearly dictates otherwise.

As used herein, “liquid vehicle,” “vehicle,” or “liquid medium” refers to the fluid in which the pigment of the present disclosure can be dispersed to form an ink-jet ink. Such liquid vehicles and vehicle components are known in the art. Typical liquid vehicles can include but are not limited to a mixture of a variety of different agents, such as surfactants, co-solvents, buffers, biocides, sequestering agents, compatibility agents, antifoaming agents, oils, emulsifiers, viscosity modifiers, etc.

As used herein, T_{g} is the glass transition temperature as calculated by the Fox equation: copolymer T_{g}=1/(Wa/(T_{g} A)+Wb(T_{g} B)+ . . . ) where Wa=weight fraction of monomer A in the copolymer and T_{g}A is the homopolymer T_{g} value of monomer A, Wb=weight fraction of monomer B and T_{g}B is the homopolymer T_{g} value of monomer B, etc.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe not only pigment colorants, but other pigments such as organometallics, ferrites, ceramics, etc. In one specific embodiment, however, the pigment is a pigment colorant.

As used herein, “RAFT reagent” refers to a compound that controls polymerization for an active free radical polymerization method in a reversible addition-fragmentation chain transfer process (RAFT process). Such a process can be used to prepare polymers with narrow molecular weight distribution and further control the polymer chain length.

As used herein, “binder” generally refers to a polymer or polymers used in ink-jet inks. Such a binder is distinct from the latex polymers or other polymers that encapsulate the pigment as described herein. As such, a reference to such a binder refers to polymers that do not encapsulate the pigment.

As used herein, the term “shear” refers to mechanical rotor devices, such as mills or mixers, which are capable of high speed mixing, e.g., tip speeds of 1 m/sec to 5 m/sec (1000 ft/min) forming an emulsion, and generally include an external mechanically driven power device to drive energy into the stream of products to be reacted. However, speeds in excess of 5 m/sec (1000 ft/min) can also be used. A shear device can combine high tip speeds with a very small shear gap to produce significant friction on the material being processed. Accordingly, a local high pressure, e.g., from 5,000 psi up to 25,000 psi and elevated temperatures at the tip of the shear mixer can be produced during operation. In one embodiment, the local pressure can be higher than 25,000 psi. However, such embodiments are not limiting as the local pressure further depends on the tip speed, fluid viscosity, and the rotor-stator gap during operation. As such, it is understood that one skilled in the art may alter the presently listed variables and still provide shear.

As used herein, the term “uniform encapsulated pigment,” “uniform,” or “uniformly” when referring to encapsulated pigments refers to a pigment that has been encapsulated by a polymer and has asperities from the surface of the encapsulated pigment of no more than about 100 nm.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Generally, attempts to improve printed ink waterfastness and fade resistance have led to increasing use of pigments as the colorant of an ink-jet ink. Since resistance to smear and smudge, on both plain paper (highlighter smear, thumb smudge) and brochure/photo media (resistance to scuff and scratch), are major challenges when using pigmented inks, various solutions have been attempted to eliminate or reduce these drawbacks, e.g., the addition of polymeric binders to the inks. Such binders, when associated with the pigment particles on the print media, are expected to increase durability by forming a protective layer over the particles. To ensure that the pigment and the binder are closely associated on the print media, an excess of binder is generally required. However, this leads to a high amount of solids in the ink. Ideally, a durable binder should form a protective film over the pigment particles that does not dissolve or rub off when wetted. For satisfactory water resistance, the binder should be hydrophobic. However, all of these otherwise desirable attributes (e.g., high solids, low T_{g}, hydrophobicity) typically lead to jettability problems in water-based thermal ink-jet inks.

Accordingly, there is interest in developing the ability to achieve close association of pigment particles and polymeric binder on a print medium without the need for excess binder in the ink, and without detrimentally affecting ink viscosity or drop ejection. Such interest has lead to general encapsulation of pigments with polymers. However, with this background in mind, it has been recognized (as described herein) that such encapsulation does not generally provide a uniform and/or fully encapsulated pigment. Despite the fact that some in the literature proclaim uniform and/or complete encapsulation, this is not typically the case. Such lack of uniformity and/or full encapsulation lowers overall print performance. As such, it has been discovered that encapsulating pigment using RAFT reagents can provide full encapsulation and substantially uniformity of the pigments. Additionally, such RAFT reagents provide better control of the radical process during polymerization allowing for increased control over polydispersity and structure, e.g., block copolymerization rather than random.

In accordance with this, the present disclosure is drawn to compositions and methods using RAFT reagents for encapsulating pigments for use in ink-jet ink applications. It is noted that when discussing the present compositions or associated methods, each of these discussions can be considered applicable to each of these embodiments, whether or not they are explicitly discussed in the context of that embodiment. Thus, for example, in discussing a monomer present in a polymer encapsulated pigment, such a monomer can also be used in a method for encapsulating the pigment, and vice versa.

With these definitions and the above discussion in mind, an encapsulated pigment can comprise a pigment and a polymer encapsulating the pigment, where the polymer comprises a monomer and a RAFT reagent. Additionally, a method of encapsulating pigments can comprise dispersing a pigment in an aqueous solution to form a pigment dispersion, adding a monomer to the pigment dispersion, adding a RAFT reagent to the pigment dispersion, and polymerizing the monomer using the RAFT reagent in the presence of the pigment to form an encapsulated pigment. Further, the present disclosure provides ink-jet inks comprising the encapsulated pigments described herein.

In one embodiment, the pigments described herein can be any pigment known in the art that imparts color. Such pigments include, without limitation, black including carbon black, magenta, yellow, blue, cyan, etc. Additionally, the pigments may be used with a separate dispersant, e.g., surfactant or polymer dispersant, and/or can be self-dispersed, e.g., small molecule- or polymer-modified pigment surface.

The RAFT reagents described herein can be present on the terminal ends of a plurality of the polymers encapsulating the pigment. While, the encapsulated pigments can be surface treated after formation to remove RAFT reagents on the surface of the encapsulated pigments, the RAFT reagent will generally be present in the polymer layer encapsulating the pigment below the surface. As such, the present encapsulated pigments generally contain at least residual units of the RAFT reagent. Additionally, the present encapsulated pigments can be structurally different than general encapsulated pigments manufactured by non-RAFT methods, including free-radical emulsion techniques. As such, these other methods do not produce an encapsulated pigment comprising a RAFT reagent in the polymer. The RAFT reagent can be present in the encapsulated pigment from about 0.01 wt % to about 30 wt %. In one embodiment, the RAFT reagent can be selected from the group consisting of dithioesters, dithiocarbamates, trithiocarbonates, derivatives thereof, and mixtures thereof. Example of RAFT reagents for use with the present invention include:

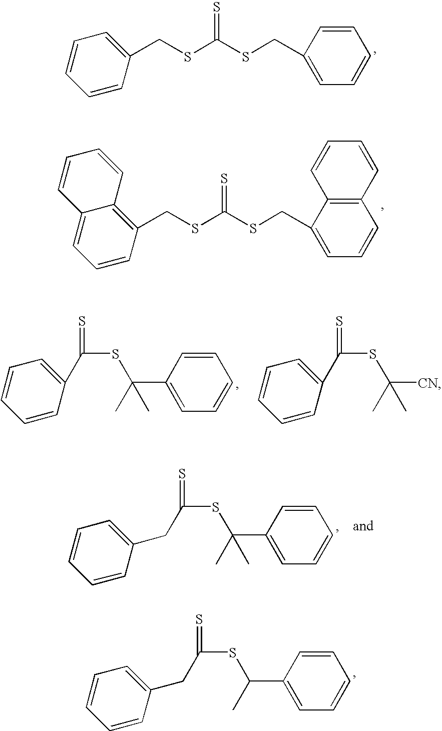

which can also be substituted. In one embodiment, the RAFT reagent can be a dithioester. In another embodiment, the RAFT reagent can be a dithiocarbamate. In yet another embodiment, the RAFT reagent can be a trithiocarbonate.

The monomers described herein can be any of a number of compounds capable of forming a polymer. In one embodiment, the monomer can be selected from the group consisting of a hydrophobic monomer, a hydrophilic monomer, and combinations thereof. In another embodiment, the encapsulated pigment can comprise a hydrophilic monomer. Additionally, the hydrophilic monomer can be present in the encapsulated pigment at from about 0.1 wt % to about 25 wt %. Suitable hydrophilic monomers include those containing an ionizable functional group or are otherwise capable of forming an ionic charge after polymerization, as well as those that are capable of hydrogen bonding with water or otherwise capable of being solvated in water. In one embodiment, the hydrophilic monomers can be anionic hydrophilic monomers, nonionic hydrophilic monomers, and cationic hydrophilic monomers. As such, hydrophilic monomers can include, without limitation, acrylic acid, methacrylic acid, ethacrylic acid, dimethylacrylic acid, maleic anhydride, vinylsulfonate, cyanoacrylic acid, methylenemalonic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, methacryloyloxyethyl succinate, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, ethylene glycol methacrylate phosphate, vinyl benzoic acid, 2-acrylamido-2-methyl-1-propanesulfonic acid, [2-(methacryloyloxy)ethyl]trimethylammonium chloride, [3-(methacryloylamino)propyl]trimethylammonium chloride, [3-(methacryloylamino)propyl]dimethyl(3-sulfopropyl)ammonium hydroxide inner salt, 3-sulfopropyl methacrylate, copolymers of polyethylene glycols, poly(ethylene glycol), poly(propylene glycol), copolymers of ethylene glycol, copolymers of propylene glycol, formamides, N-vinyl fromamide, acrylamide, methacrylamide, N-vinyl pyrrolidone, water-soluble hydroxy-substituted acrylic or methacrylic esters, combinations thereof, derivatives thereof, and mixtures thereof.

In another embodiment, the hydrophilic monomer can be an acidic monomer. As such, the acidic monomer can be selected from the group consisting of, acrylic acid, methacrylic acid, ethacrylic acid, dimethylacrylic acid, maleic anhydride, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, combinations thereof, derivatives thereof, and mixtures thereof.

In another embodiment, the encapsulated pigment can comprise a hydrophobic monomer. The hydrophobic monomer can be present in the encapsulated pigment from about 2 wt % to about 99 wt %. Suitable hydrophobic monomers generally include monomers known in the latex arts for synthesizing latexes that generally are not solvated by water. Hydrophobic monomers include, without limitation, styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, octadecyl acrylate, stearyl methacrylate, vinylbenzyl chloride, isobornyl acrylate, tetrahydrofurfuryl acrylate, 2-phenoxyethyl methacrylate, ethoxylated nonyl phenol methacrylate, isobornyl methacrylate, cyclohexyl methacrylate, t-butyl methacrylate, n-octyl methacrylate, lauryl methacrylate, trydecyl methacrylate, alkoxylated tetrahydrofurfuryl acrylate, isodecyl acrylate, isobornylmethacrylate, combinations thereof, derivatives thereof, and mixtures thereof.

Additionally, in one embodiment, the encapsulated pigment can comprise a hydrophilic monomer, a hydrophobic monomer, and a RAFT reagent, as described herein. In one aspect, the hydrophilic monomer can be an acid monomer and the hydrophobic monomer can be a hydrophobic acrylate monomer. Further, such an encapsulated pigment can have a calculated T_{g} from about −40° C. to about 125° C. In one embodiment, the calculated T_{g} can be from about 0° C. to about 75° C., and in one aspect, can be from 35° C. to about 50° C.

Additionally, the polymer encapsulating the pigment can be cross-linked to provide further durability. Suitable cross-linking monomers include polyfunctional monomers and oligomers that contain an organic functional group available for cross-linking after polymerization. Such cross-linking monomers include, without limitation, ethylene glycol dimethacrylate, 1,6-hexanediol diacrylate, tertaethylene glycol diacrylate, tripropylene glycol diacrylate, ethoxylated bisphenol A diacrylate, pentaerythritol tri- and tetraacrylate, combinations thereof, mixtures thereof, and derivatives thereof.

While the present method for encapsulating pigment generally comprises dispersing the pigment, adding a monomer to the pigment dispersion, adding a RAFT reagent to the pigment dispersion, and polymerizing the monomer using the RAFT reagent to form the encapsulated pigment, it is understood that one skilled in the art may modify the present method while still providing the present encapsulated pigments. Generally, the monomer(s) described herein can be generally polymerized in situ to form an encapsulating polymer in the presence of the pigment such that the pigment becomes encapsulating by the encapsulating polymer. Additionally, the mixture can have a monomer to pigment ratio of from about 0.25:1 to about 5:1. In one embodiment, the monomer to pigment ratio can be from about 0.5:1 to about 3:1. In another embodiment, the monomer to pigment ratio can be from about 1:1 to about 3:1.

Even though the process steps have been described in a certain order, such steps are not limited to such an order, nor are the embodiments described herein meant to be limited to any such order, unless specifically stated. For example, the step of adding the RAFT reagent has been described after the step of adding the monomer. However, such steps may be performed in any order or may be combined. For example, adding the monomer and adding the RAFT reagent can be performed simultaneously or adding the monomer and adding the RAFT reagent can be performed sequentially. Additionally, the present methods described herein can further comprise the step of preparing the RAFT reagent before incorporation into the pigment dispersion. Such preparation can further be tailored based on the monomers desired for the polymer.

Additionally, as previously discussed, the present methods can provide a fully encapsulated pigment and/or a substantially uniform encapsulated pigment. In one embodiment, the step of polymerizing can be performed devoid of a surfactant. Alternately, the method can further comprise adding a surfactant prior to polymerizing. In another embodiment, the method can be devoid of shearing. Alternately, the method can further comprise shearing.

Further, the present methods can be used to provide a specific polymer structure. While general radical processes provide a random structure when polymerizing more than one polymer, the present methods using RAFT reagents can provide an ordered polymer structure. As such, the polymers encapsulating the pigments described herein can have a block copolymer structure. Additionally, the polymers encapsulating the pigments can have blocked structure or, in one aspect, can have a random structure. When referring to copolymer, such a copolymer includes any polymer having more than one monomer.

The particle size of the encapsulated pigment is typically greater than 40 nm. Typically, the selected encapsulated pigment particulate can be sized below 350 nm. In one embodiment, the encapsulated pigment particulate diameter can be from about 50 to 350 nm, though diameters outside of this range may be appropriate as well for certain applications. In another embodiment, the range can be from about 150 nm to about 250 nm. The encapsulated pigment particulates can be stabilized through the incorporation of a hydrophilic monomer that promotes surface charge, including those previously discussed. The charge forming monomers can be neutralized after polymerization to form salts. For example, such salts may be formed through the reaction of a monomer carboxylic acid with potassium hydroxide or other similar base.

Alternately, the encapsulated pigment particulates can be further stabilized by addition of surfactants. As such, in one embodiment, the encapsulated pigment particulates can further comprise a reactive surfactant during the polymerization process. Generally, the reactive surfactant contains hydrophobic moieties that can be covalently bound to the surface of the encapsulated pigment particulate. Additionally, such a reactive surfactant can be incorporated during the polymerization via appropriate organic groups, e.g., a vinyl group, such that the surface of the encapsulated pigment contains the reactive surfactant. Generally, the reactive surfactant can contain hydrophilic groups that allow the encapsulated pigment particulate to be dispersed and/or stabilized in an aqueous medium. The hydrophilic groups can be anionic, cationic, nonionic, or zwitterionic. For example, suitable anionic groups include sulfonate, phosphonate, and carboxylate groups; suitable cationic groups include amine groups; and suitable nonionic groups include polyethelyene oxide, imidazole and amido groups As such, in one embodiment, the reactive surfactants can be functionalized ethylene glycol acrylates, including the SIPOMER® series of surfactants from Rhodia.

With these parameters in place regarding some of the possible encapsulated pigment particulates that can be formed, a discussion of dispersion fluids, e.g., inks, etc., is useful to exemplify how these encapsulate pigment particulates can be implemented for use in accordance with an embodiment of the present disclosure. Typically, inks include a colorant dispersed in a liquid vehicle. Typical liquid vehicle formulation that can be used with the encapsulated pigment particulates described herein can include water, and optionally, one or more co-solvents present in total at from 0 wt % to 30 wt %, depending on the jetting architecture. Further, one or more non-ionic, cationic, and/or anionic surfactant can be present, ranging from 0 wt % to 10.0 wt %. The balance of the formulation can be purified water, or other vehicle components known in the art, such as biocides, viscosity modifiers, materials for pH adjustment, sequestering agents, preservatives, and the like. Typically, the liquid vehicle is predominantly water.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include trimethylolpropane, 2-pyrrolidinone, and 1,5-pentanediol.

One or more of many surfactants can also be used as are known by those skilled in the art of ink formulation and may be alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the formulation of this disclosure may range from 0 wt % to 10.0 wt %. It is to be noted that the surfactant that is described as being usable in the liquid vehicle is not the same as the surfactant that is described as being adhered to the surface of the encapsulated pigment particulate, though many of the same surfactants can be used for either purpose.

Consistent with the formulation of this disclosure, various other additives may be employed to optimize the properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), and combinations thereof.

Sequestering agents, such as EDTA (ethylene diamine tetra acetic acid), may be included to eliminate the deleterious effects of heavy metal impurities, and buffer solutions may be used to control the pH of the ink. From 0 wt % to 2.0 wt %, for example, can be used. Viscosity modifiers and buffers may also be present, as well as other additives known to those skilled in the art to modify properties of the ink as desired. Such additives can be present at from 0 wt % to 20.0 wt %.

In accordance with embodiments of the present disclosure, the encapsulated pigment particulates of the present disclosure can be present in an ink-jet ink at from about 0.5 wt % to about 40 wt %. In one embodiment, the encapsulated pigment particulates of the present disclosure can be present in an ink-jet ink at from about 1 wt % to about 15 wt % or, in one aspect from about 2 wt % to about 6 wt %.

### EXAMPLES

The following examples illustrate embodiments of the disclosure that are presently known. Thus, these examples should not be considered as limitations of the disclosure, but are merely in place to teach how to make compositions of the present disclosure. As such, a representative number of compositions and their method of manufacture are disclosed herein.

### Example 1

### Pigment Dispersion

A carbon black pigment, PRINTEX® 25 from Degussa (186.4 g), was mixed with a surfactant, LUTENSOL® AT 50 (C₁₆-C₁₈ fatty alcohol ethoxylates) from BASF (18.64 g), and stirred well with water (2020 ml) for 2 days. It was ultrasonicated at 90% amplitude for 1 hour twice while cooling the solution with water. Further, it was microfluidized at 90 psi for 3 passes to obtain a solid % of 10.2 wt % (equivalent to 9.27 wt % of pigment concentration).

### Example 2

### RAFT Reagent Synthesis

Sodium sulfide (24 g) was stirred in water (40 ml). Tetrabutylammonium bromide (3.22 g), acetone (200 ml) and carbon disulfide (20 ml) were added and stirred at ambient temperature for 19 h. A solution of sodium 2-bromopropionate was made using 2-bromopropionic acid (30.6 g) with cold 25% sodium hydroxide solution (32 g). This solution was added to the sodium sulfide solution and stirred at ambient temperature for 3 h. It was acidified with 3M HCl (80 ml) and evaporated to dryness using rotary evaporator. The resulting solid was partitioned between water (100 ml) and 3:1 diethyl ether and dichloromethane (250 ml). The organic layer was collected, dried over sodium sulfate and solvent was evaporated. The solid obtained was recrystalized from ethyl acetate/toluene mixture to obtain the RAFT reagent.

### Example 3

### Encapsulation of Carbon Black Pigment

The pigment dispersion from Example 1 (54.46 g) was stirred. A mixture of acrylic acid (0.4 g) and isobornyl methacrylate (0.3 g) followed by 4,4′-azobis(4-cyanopentanoic acid) (0.075 g) and RAFT agent from Example 2 (0.12 g) were added. Then 20% potassium hydroxide (1.7 g) was added. The reaction mixture was saturated with nitrogen and placed in an oil bath at 70 C for 1 h. Then isobornyl methacrylate (6.8 g) was added dropwise over a period of 1 h. After 3 h, more initiator 4,4′-azobis(4-cyanopentanoic acid) (0.015 g) was added. Heating was continued for another 17 hours and cooled. It was filtered with 200 mesh filter to obtain encapsulated pigment.

While the disclosure has been described with reference to certain preferred embodiments, those skilled in the art will appreciate that various modifications, changes, omissions, and substitutions can be made without departing from the spirit of the disclosure. It is intended, therefore, that the invention be limited only by the scope of the following claims.

What is claimed is:

1. An encapsulated pigment, comprising:
a pigment; and
a polymer encapsulating the pigment, said polymer comprising:
a polymerized monomer; and
a RAFT reagent.

2. The encapsulated pigment of claim 1, wherein the RAFT reagent is present on the terminal ends of a plurality of the polymer chains encapsulating the pigment.

3. The encapsulated pigment of claim 1, wherein the RAFT reagent is selected from the group consisting of dithioesters, dithiocarbamates, trithiocarbonates, derivatives thereof, and mixtures thereof.

4. The encapsulated pigment of claim 1, wherein the monomer is selected from the group consisting of a hydrophobic monomer, a hydrophilic monomer, combinations thereof, and mixtures thereof.

5. The encapsulated pigment of claim 1, wherein the encapsulated pigment is fully encapsulated and the polymer is uniform in thickness over the pigment.

6. The encapsulated pigment of claim 1, wherein the polymer encapsulating the pigment is a block copolymer.

7. The encapsulated pigment of claim 1, wherein the polymer comprises a hydrophilic monomer, a hydrophobic monomer, and a RAFT reagent.

8. The encapsulated pigment of claim 7, wherein the T_{g} of the polymer is 35° C. to 50° C., the hydrophilic monomer is an acid monomer, the hydrophobic monomer is a hydrophobic acrylate monomer, and the RAFT reagent is a dithioester.

9. An ink-jet ink comprising a liquid vehicle and the encapsulated pigment of claim 1.

10. A method of encapsulating pigments, comprising:
dispersing a pigment in an aqueous solution to form a pigment dispersion;
adding a monomer to the pigment dispersion;
adding a RAFT reagent to the pigment dispersion; and
polymerizing the monomer using the RAFT reagent in the presence of the pigment to form an encapsulated pigment.

11. The method of claim 10, wherein polymerizing provides an encapsulated pigment that is fully encapsulated by a polymer.

12. The method of claim 10, wherein polymerizing provides an encapsulated pigment that is uniformly encapsulated by a polymer.

13. The method of claim 10, wherein the polymerizing is performed devoid of a surfactant.

14. The method of claim 10, further comprising adding a surfactant prior to polymerizing.

15. The method of claim 10, wherein the method is devoid of shearing.

16. The method of claim 10, further comprising shearing.

17. The method of claim 10, wherein adding the monomer and adding the RAFT reagent is performed simultaneously.

18. The method of claim 10, wherein adding the monomer and adding the RAFT reagent is performed sequentially.

19. The method of claim 10, wherein the RAFT reagent is selected from the group consisting of dithioesters, dithiocarbamates, trithiocarbonates, derivatives thereof, and mixtures thereof.

20. An ink-jet ink, comprising a liquid vehicle and the encapsulated pigment manufactured by the method of claim 10.
